(19) United States
(12) Patent Application Publication
(10) Pub. No.: US 2016/0369561 A1
(43) Pub. Date: Dec. 22, 2016

(54) TRANSITION DEVICE FOR EXTENSION LADDERS

(71) Applicant: Ronald Barry Thomas Jones, Ramsey Isle of Man (GB)

(72) Inventor: Ronald Barry Thomas Jones, Ramsey Isle of Man (GB)

(21) Appl. No.: 15/102,865

(22) PCT Filed: Oct. 28, 2014
(86) PCT No.: PCT/GB2014/053201

§ 371 Date: Jun. 8, 2016

(30) Foreign Application Priority Data
Oct. 28, 2013 (GB) 1318943.6
Jan. 29, 2014 (GB) 1401472.4
Jul. 14, 2014 (GB) 1412497.8

(51) Int. Cl. E06C 7/08

(52) U.S. Cl. CPC E06C 7/08

(57) ABSTRACT

A transition device for fitting to an extension ladder includes a single elongate rung portion and two hook-shaped arm portions at respective opposite ends of the rung portion. The hook-shaped arm portions have respective wing formations that project longitudinally from each end of the transition device 110. The hook-shaped arm portions are engaged over the uppermost exposed rung of the lower section of the extension ladder, so that the wing formations abut the uprights of the ladder and prevent movement or rotation of the device. The transition device 110 acts to increase the forward extension of the rung to enables a user to step safely over the transition between the lower and upper sections.

The present invention relates to a transition device for fitting to the uppermost rung of the lower section of an extension ladder having upper and lower sections, so as to reduce the transition when stepping between the upper and lower sections of the ladder.

An extension ladder generally comprises two uprights and a plurality of rungs or steps fixed between the uprights. In use, the ladder is positioned against a structure in an inclined upright orientation, so that a user can climb the ladder from a front face of the ladder.

Extension ladders, otherwise known as telescopic ladders, are divided into two or more ladder sections which can be slid longitudinally apart to extend the length of the ladder, or slid together over one another for convenient storage. Where the ladder has two sections, they can further be defined as upper and lower sections relative to their position on the ladder.

In use, when the extension ladder is extended, the user ascends by climbing the lower section and then steps over the transition between lower and upper sections to climb the upper section. To descend the ladder, the user steps over the transition from upper to lower sections. Due to the arrangement of the two sections, the rungs of the upper section are often more forwardly disposed than the lower section, so it is easy for the user to miss their footing in the transition when ascending or descending the ladder. This can be dangerous for the user of the ladder and others around.

In order to solve this problem, it is known to provide a transition device for fitting to an extension ladder which is arranged to level the transition between the upper and lower sections thereof. One such device is disclosed in DE3500148 A1, the transition device comprising two metal uprights and two rungs extending therebetween. The top of each upright has a hook for suspending the device from the bottom rung of the upper section of the ladder.

Although the transition device disclosed in DE3500148 A1 provides one solution to the above-mentioned problem associated with the transition when stepping between the lower and upper sections of an extension ladder, there are several drawbacks. The transition device disclosed in DE3500148 A1 is relatively bulky in construction and is therefore difficult and heavy to transport and use. Also, since the transition device is merely suspended from the bottom rung of the upper section of the ladder, there is a risk that the device will rotate or move when stepped on by the user.

We have now devised an improved transition device for an extension ladder.

In accordance with the present invention, as seen from a first aspect, there is provided a transition device for fitting to the uppermost exposed rung of the lower section of an extension ladder having or more uprights and upper and lower ladder sections, the device comprising a single elongate rung portion with upper and lower faces, a rung engagement means, and respective wing formations that project longitudinally of each end of the transition device.

In use, a user will engage the rung engagement means of the transition device with the uppermost exposed or free rung of the bottom section of the extension ladder from the front face, so as to reduce the transition when stepping between the upper and lower sections of the ladder. The wing formations on the transition device abut respective uprights of the ladder and prevent movement or downwards rotation of the device about a vertical axis when the device is stepped upon, thereby making it more stable.

Preferably, the rung engagement means comprises at least one hook-shaped portion.

The rung engagement means may comprise a single hook-shaped portion extending substantially the full length of the rung portion. Alternatively, the rung engagement means may comprise a pair of hook-shaped portions at respective opposite ends thereof.

The rung portion and hook-shaped portion or portions may be welded or joined together. Alternatively, the rung portion and hook-shaped portion or portions may be formed as a one-piece extruded member.

In one embodiment of the present invention as seen from the first aspect, cut outs are formed in the ends of the extruded member to form said wing formations that project longitudinally of each end of the transition device.

Preferably, the wing formations project longitudinally from each end of the transition device, axially with the rung portion.

In one embodiment, the wing formations may comprise substantially flat abutment faces which extend longitudinally of the device and which are arranged to abut a front face of the uprights of the ladder. In an alternative embodiment, the wings may abut a back face of the uprights of the ladder.

Also in accordance with the present invention, as seen from a second aspect, there is provided a transition device for fitting to the uppermost exposed rung of the lower section of an extension ladder having one or more uprights and upper and lower ladder sections, the device comprising: a single elongate rung portion with upper and lower faces, a rung engagement means and a lock arranged to provide a force substantially parallel to the elongate rung portion such that the transition device engages with the one or more uprights.

Preferably, the rung engagement means comprises at least one hook-shaped portion.

The rung engagement means may comprise a single hook-shaped portion extending substantially the full length of the rung portion. Alternatively, the rung engagement means may comprise a pair of hook-shaped portions at respective opposite ends thereof.

The rung portion and hook-shaped portion or portions may be welded or joined together. Alternatively, the rung portion and hook-shaped portion or portions may be formed as a one-piece extruded member.

Preferably, the lock comprises two hooks that project longitudinally from each end of the device and a spring portion arranged to bias the hooks towards each other longitudinally of the device.

In one embodiment, the one or more uprights of the extension ladder may comprise an I-section on a side face and the lock may engage with said I-section.

In an alternative embodiment, the uppermost exposed rung of the lower section of the extension ladder may be hollow and the lock may engage with an aperture created by said hollow rung on a side face of the upright.

Also in accordance with the present invention, as seen from a third aspect, there is also provided an alternative embodiment of a transition device for fitting to the uppermost exposed rung of the lower section of an extension ladder having one or more uprights and upper and lower ladder sections, the device comprising: a single elongate rung portion with upper and lower faces, a rung engagement means and a clamp arranged to abut said exposed rung of the extension ladder.

Preferably, the clamp comprises a screw-bolt and a disc fixed to the end of the screw-bolt. Preferably, the disc is arranged to abut a rear side of said exposed rung. Advantageously, the clamp provides a tight and secure hold between the transition device and the uppermost rung of the extension ladder.

The clamp may comprise a screw-bolt comprising a head at a first end and a clamping member at a second end, the clamping member arranged for engagement with a portion of the transition device such that rotation of the head causes linear movement of the clamping member to secure the transition device to an exposed rung of a ladder.

The clamp comprising at least one compartment for the storage of equipment.

Preferably, the rung engagement means comprises at least one hook-shaped portion.

The rung engagement means may comprise a single hook-shaped portion extending substantially the full length of the rung portion. Alternatively, the rung engagement means may comprise a pair of hook-shaped portions at respective opposite ends thereof.

The rung portion and hook-shaped portion or portions may be welded or joined together. Alternatively, the rung portion and hook-shaped portion or portions may be formed as a one-piece extruded member.

Also in accordance with the present invention, as seen from a fourth aspect, there is provided a transition device for fitting to the uppermost exposed rung of the lower section of an extension ladder having upper and lower ladder sections, the device comprising:
front and rear engagement formations, wherein the front engagement formation is arranged to abut a front face of the uprights of the ladder and wherein the rear engagement formation is arranged to abut a rear face of the uprights of the ladder;
the device further comprising a single elongate rung portion with upper and lower faces arranged between said front and rear engagement formations;
wherein the arrangement of the front and rear engagement formations and rung portion provide a rung engagement means.

Advantageously, the front and rear engagement formations brace against the uprights of the ladder and stop the rung device rotating, so that the user has a secure place to step.

The following preferable features may apply to a transition device as seen from the first, second, third or fourth aspects of the present invention.

Preferably, the transition device is formed as a one-piece extruded member, for example, by casting or moulding.

Preferably, the transition device are made of a metal such as aluminium. Alternatively, the transition device is made of a plastics material or of fiberglass.

Preferably, the rung portion is hollow.

Preferably, the rung portion has a non-slip surface formation. Preferably, the non-slip formation comprises a plurality of longitudinal formations on the upper face that extend between each end of the rung portion. The non-slip formation provides grip between the rung portion and the foot of the user when in contact with the transition device.

Advantageously, the transition device of the present invention as seen from the first, second, third or fourth aspect comprises just one rung and no uprights making it a lighter, smaller and a more convenient alternative to the device disclosed in DE3500148 A1. It is less expensive to manufacture and easier to display at point of sale.

In accordance with the present invention, as seen from a fifth aspect, there is provided an extension ladder assembly comprising an extension ladder having upper and lower ladder sections and a transition device, each ladder section comprising a pair of uprights and a plurality of rungs extending therebetween, the device comprising a single elongate rung portion with upper and lower faces and a rung engagement means which detachably engages the uppermost exposed rung of the lower section of the ladder.

Preferably, the extension ladder assembly comprises a transition device according to an embodiment of the present invention as hereinbefore described.

Embodiments of the present invention will now be described by way of example only and with reference to the accompanying drawings, in which:

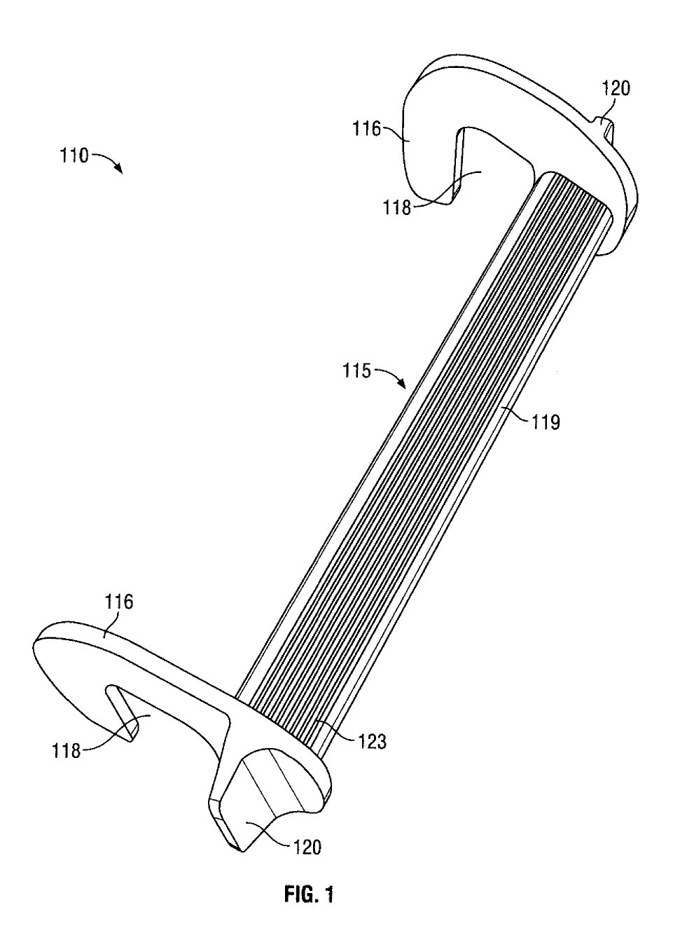

FIG. 1 is a perspective view of a transition device for an extension ladder in accordance with the present invention, as seen from the first aspect;

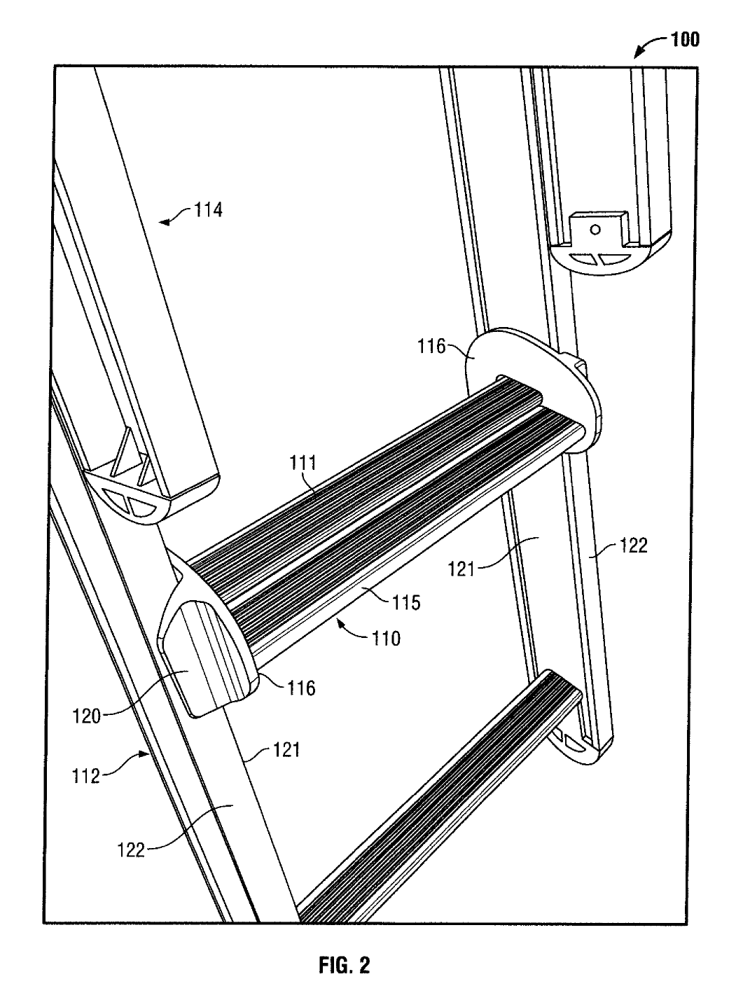

FIG. 2 is a perspective view of the transition device of FIG. 1 in use on an extension ladder in accordance with the present invention as seen from the fifth aspect, the transition device engaged with the uppermost rung of the bottom section;

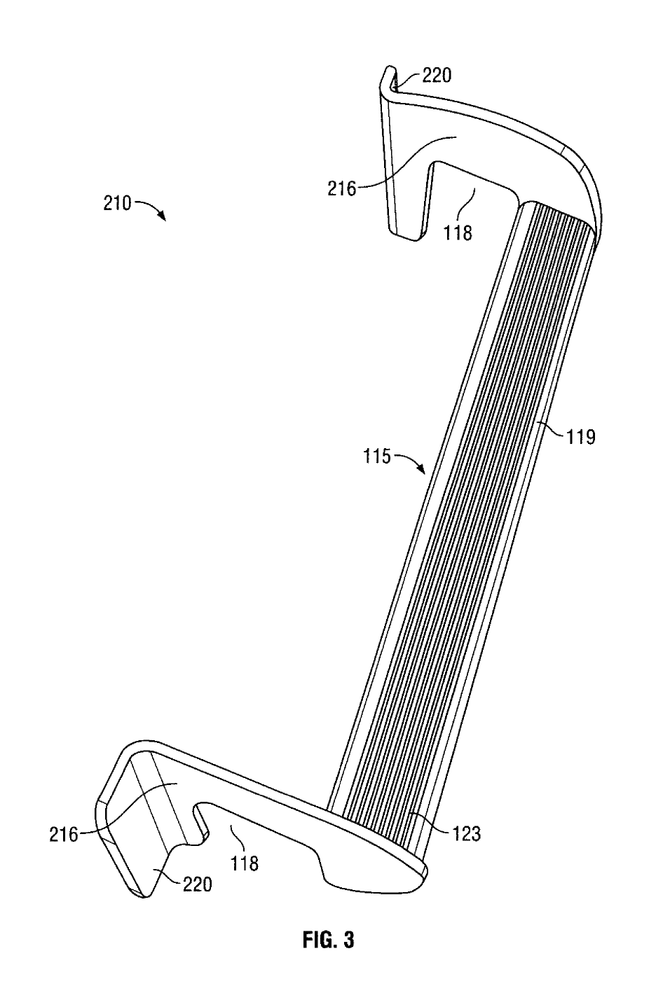

FIG. 3 is a perspective view of an alternative embodiment of a transition device for an extension ladder in accordance with the present invention, as seen from the first aspect;

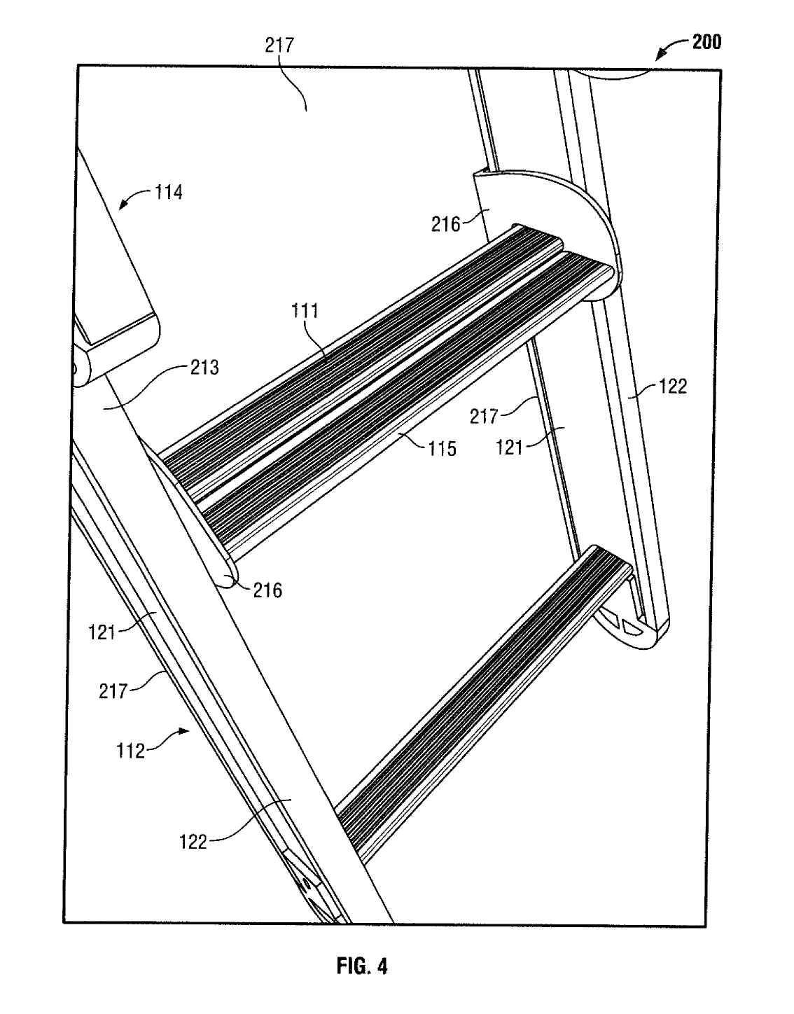

FIG. 4 is a perspective view of the transition device of FIG. 3 in use on an extension ladder in accordance with the present invention as seen from the fifth aspect, the transition device engaged with the uppermost rung of the bottom section of the extension ladder;

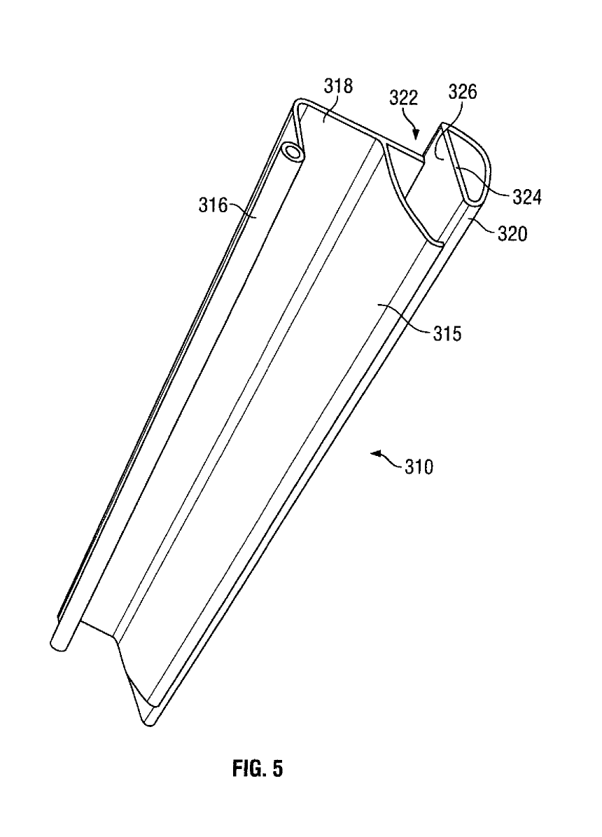

FIG. 5 is a bottom perspective view of an alternative embodiment of a transition device for an extension ladder in accordance with the present invention, as seen from the first aspect;

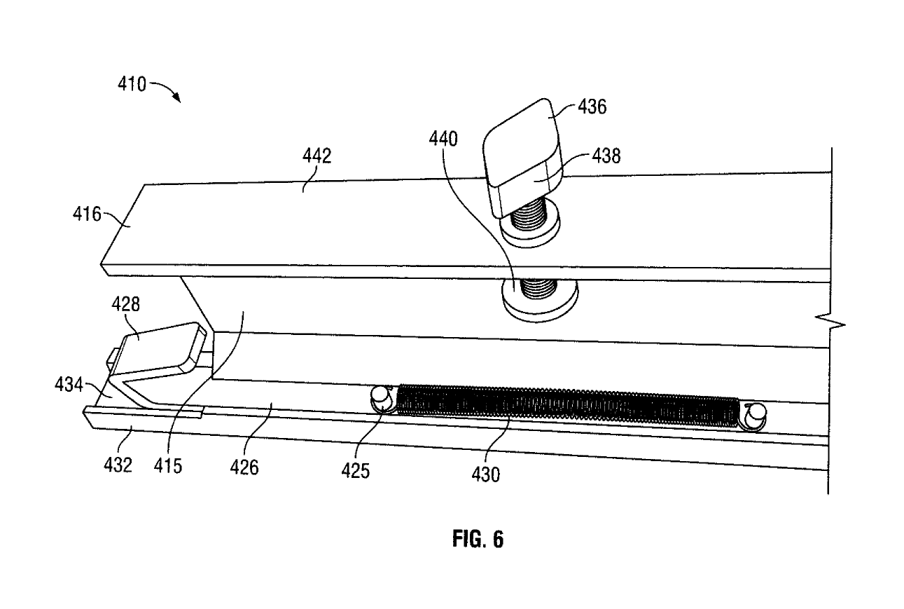

FIG. 6 is a bottom perspective view of a transition device for an extension ladder in accordance with the present invention as seen from the second and third aspects, the transition device comprising a lock and a clamp;

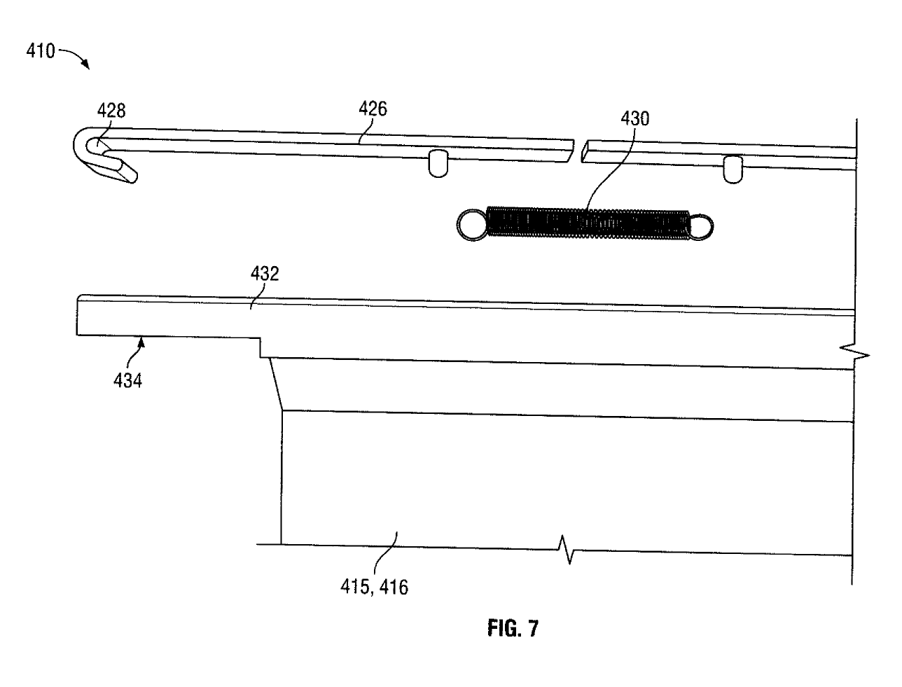

FIG. 7 is an exploded view of parts of the lock of the transition device of FIG. 6;

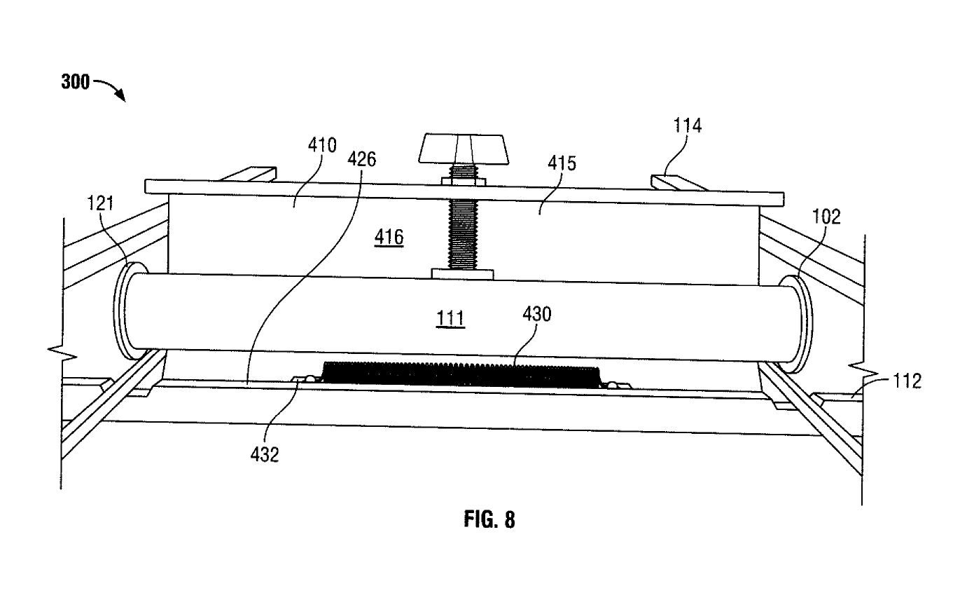

FIG. 8 is a bottom side view of the transition device of FIG. 6 in use on an extension ladder in accordance with the present invention as seen from the fifth aspect;

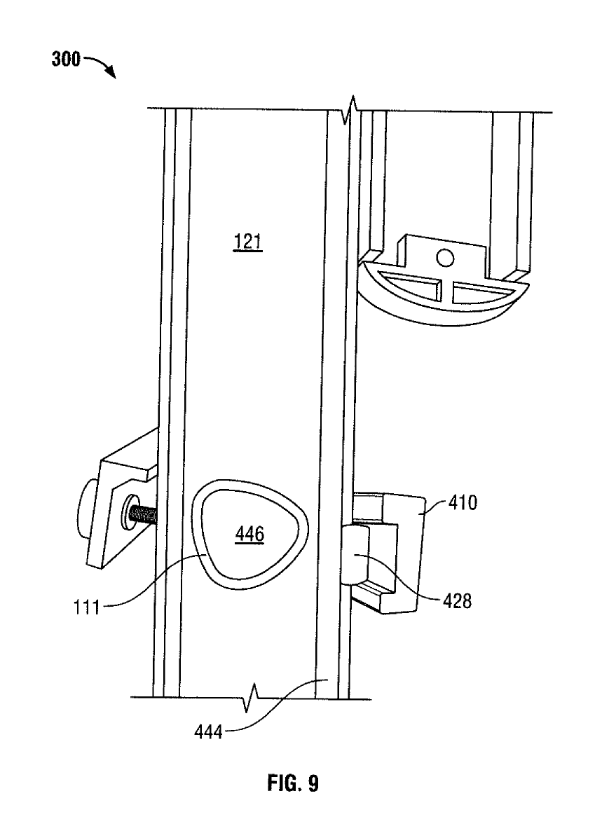

FIG. 9 is a side view of the transition device in use on an extension ladder, as shown in FIG. 8;

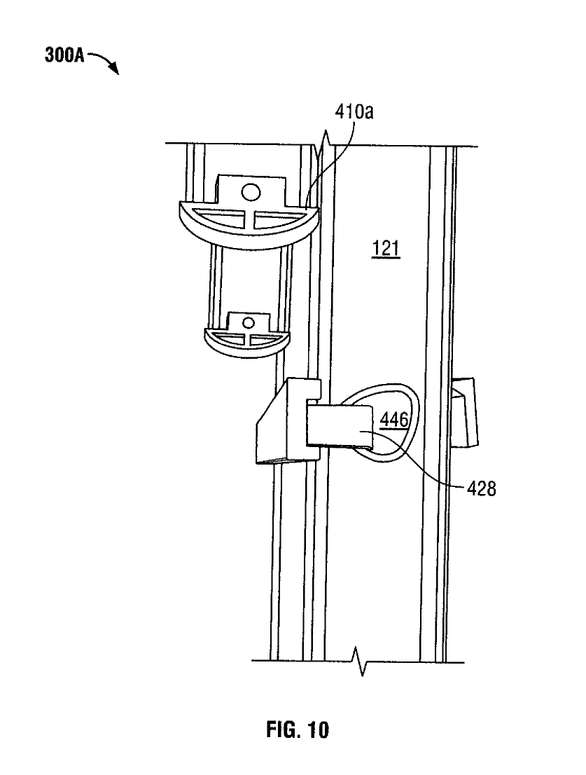

FIG. 10 is a side view of an embodiment of a transition device similar to the transition device of FIGS. 6-8 in use on an extension ladder;

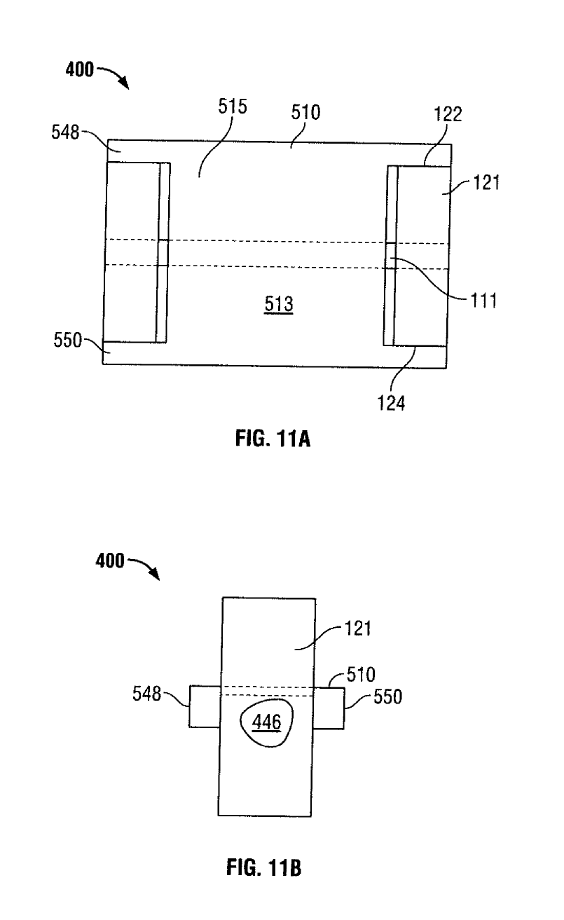

FIG. 11a is a top view of a transition device in accordance with the present invention as seen from the fourth aspect, in use on an extension ladder as seen from the fifth aspect;

FIG. 11b is a side view of the transition device of FIG. 11a in use on an extension ladder;

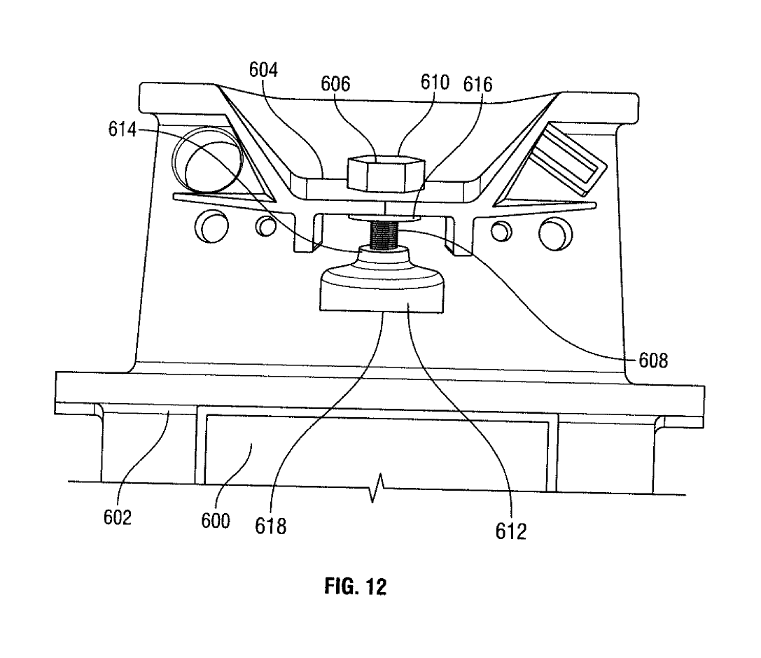

FIG. 12 is a bottom view of the rear of a transition device in accordance with an embodiment of the third aspect of the present invention; and

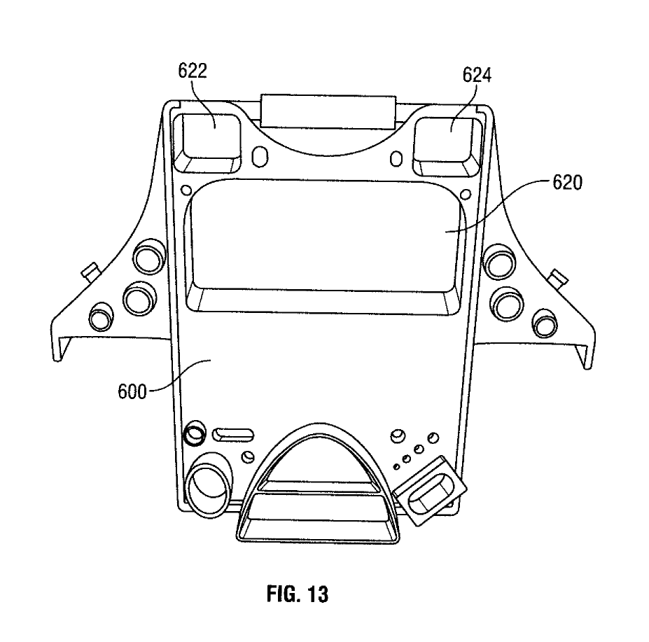

FIG. 13 is a plan view of a transition device in accordance with an embodiment of the third aspect of the present invention.

Referring to FIG. 1 of the drawings, there is shown a transition device 110 comprising a single elongate rung portion 115 having an upper face 113 and two rearwardly-extending hook-shaped arm portions 116 at respective opposite ends thereof.

The hook-shaped arm portions 116 are generally planar and lie normal to the longitudinal axis of the rung portion 115, the hook-shaped arm portions 116 being enlarged laterally towards the rear of the device 110. The hook-shaped arm portions 116 of the transition device 110 comprise a downwardly-facing slot 118 and respective wing formations 120 which project longitudinally outwards from each respective end of the transition device 110 in line with the rung portion 115 and generally perpendicular to the upper face 113 of the rung portion 115.

The upper face 113 of the rung portion 115 has a plurality of longitudinal rib formations 123 which extend between each end of the rung portion 115. The hook-shaped arm portions 116 are cast and then welded to the rung portion 115 at each respective end to create a strong joint.

Referring to FIG. 2, there is shown an extension ladder assembly 100 comprising a ladder 102 having lower and upper and ladder sections 112, 114, and the transition device 110. Each section comprises a pair of parallel uprights 121 and a plurality of rungs e.g. 111 extending therebetween.

In use, a user will climb the extension ladder 102 from the lower section 112 holding the transition device 110 of FIG. 1 and will fit the transition device 110 to the uppermost exposed rung 111 of the lower section 112 of the ladder by engaging the slot 118 on each hook-shaped arm portion 116 over the rung 111: the slots 118 have a profile suitable to tightly accommodate the rung 111.

The wing formations 120 on each hook-shaped arm 116 abut against the uprights 121 on the front face 122 of the extension ladder 102 on each side of the transition device 110 to brace it and prevent downward rotation when stepped on. The transition device 110 acts to increase the forward extension of the uppermost exposed rung 111 of the lower ladder section 112, to a point intermediate that of the next adjacent rungs of the ladder. In this manner a user will be able to step on the transition device 110 and climb safely between the lower section 112 to the upper section 114 of the extension ladder 102.

Referring to FIG. 3 of the drawings, there is shown a transition device 210 which is similar to the transition device 110 shown in FIG. 1 and like parts are given by like reference numerals. In contrast to FIG. 1, the wing formations 220 on the transition device 210 project longitudinally outward from the rear end of each respective hook-shaped arm 216, parallel to the longitudinal axis of the slot 118. In use, the transition device 210 is fitted to an extension ladder similarly to the transition device 110.

Referring to FIG. 4 of the drawings, there is shown an embodiment of the transition device 210 in which the wing formations 220 abut against the rear face 217 of the uprights 121 of the lower section 112 of the extension ladder in the extension ladder assembly 200

Referring to FIG. 5 of the drawings, there is shown a transition device 310 which is similar to the transition devices 110, 210 shown in FIGS. 1 and 3. In contrast, the transition device 310 is formed as a one-piece extruded member of plastics or aluminium and comprises a rung portion 315 and a single hook-shaped portion 316 extending the full length of the rung portion 315. The hook-shaped portion 316 defines a downwardly-facing slot 318 for engaging with the uppermost exposed rung 111 of the lower section 112 of the extension ladder.

The device further comprises cut outs 322 at the ends of the transition device 310. The cut outs 322 form two wing formations 320 that project longitudinally from each end of the transition device 310, axially in line with the rung portion 315. The wing formations 320 comprise substantially flat abutment faces 326 which are formed by exposed portions of an inner wall 324 of the extrusion and which are arranged to abut a front face of the respective uprights 121 of the ladder 102.

In use, the transition device 310 is fitted to an extension ladder similarly to the transition devices 110 and 210. In contrast, the user will fit the transition device 310 to the uppermost exposed rung 111 of the lower section 112 of the extension ladder by engaging the hook-shaped portion 316 over the rung 111. The slot 318 has a profile suitable to tightly accommodate the rung 111. The substantially flat abutment faces 326 of the inner wall 324 abut against the uprights 121 on the front face 122 of the extension ladder 102 on each side of the transition device 310 to brace it and prevent downward rotation when stepped on.

Referring to FIGS. 6 and 7 of the drawings, there is shown a transition device 410 similar to the device 310 shown in FIG. 5. The transition device 410 comprises a single elongate rung portion 415 having a single hook-shaped portion 416 extending the full length of the rung portion 415.

The transition device 410 further comprises a lock 425 comprising two longitudinally extending arms 426, each arm 426 comprising a hook 428 and arranged such that the hooks 428 are at respective opposite ends of the transition device 410. The hooks 428 are shaped to hook around the uprights of an extension ladder.

The arms 426 are substantially planar and lie flat against an inner face of a front side 432 of the elongate rung portion 415. The arms 426 are linked by a spring portion 430 joined to each arm 426 at an end that does not comprise the hook 428 respectively. The spring portion 430 provides a resilient force such that the hooks 428 are biased in a direction towards each other longitudinally of the device 410. The front side 432 of the elongate rung portion 415 projects out from opposing sides of the rung portion 415 and comprises a rail 434 such that the arms 426 can slide along the inner face of the front side 432 in a direction substantially parallel to the elongate rung portion 415, longitudinally of the device 410.

In use, the user will engage the hooks 428 of each arm 426 with the uprights of an extension ladder. The bias provided by the spring portion 430 braces the engaged hooks 428 against the uprights of the ladder and prevents the transition device 410 rotating or sliding horizontally when the transition device 410 is stepped on. This provides the user with a safe and secure place to step when transitioning between the upper and lower sections of an extension ladder.

The transition device further comprises a clamp 436 comprising a screw-bolt 438 and a disc 440 fixed to the end of the screw-bolt 438. An aperture comprising a screw thread is provided in a back side 442 of the single hook-shaped portion 416, the screw thread of the aperture being complementary to the screw-bolt 438. In use, after engaging the hook-shaped portion 416 with the uppermost exposed rung of the lower section of an extension ladder, the user will then screw the screw-bolt 438 in a direction towards the exposed rung until the disc 440 abuts a rear side of the exposed rung and the transition device 410 is clamped to the uppermost exposed rung.

The clamp 436 provides a tight and secure fit between the transition device 410 and the uppermost rung of the extension ladder. This enables the transition device 410 to provide a secure and steady place for the user to step when transitioning between the upper and lower sections of the ladder.

The clamp 436 also enables the transition device 410 to be used on extension ladders with varying dimensions. For example, the hook-shaped rung engagement portion 416 may be dimensioned to a suitable size to fit over a majority of rungs found on typical extension ladders and the clamp 436 can be used to secure the transition device 410 to the uppermost exposed rung of the extension ladder by screwing the screw-bolt 438 by a suitable amount such that the disc 440 abuts said exposed rung to clamp the transition device in place. It will be appreciated that the transition device 410 may comprise only one or both of the clamp 436 and lock 425.

Referring to FIG. 8 of the drawings, there is shown a bottom view of an extension ladder assembly 300 comprising the transition device 410 of FIGS. 6 and 7 fitted to an extension ladder 102. The ladder 102 comprises upper and lower ladder sections 114, 112, each section comprising a pair of parallel uprights 121 and a plurality of rungs extending there between. The hook-shaped portion 416 of the transition device 410 is engaged to the uppermost exposed rung 111 of the lower section 112 of the ladder 102. The front side 432 of the transition device 410 is wider than the exposed rung 111 and abuts the uprights 121 on each side of the device 410 respectively. The spring portion 430 and arms 426 of the lock 425 are visible adjacent the inner face of the front side 432 of the rung portion 415.

Referring to FIG. 9, there is shown a side view of the extension ladder assembly 300 comprising an extension ladder 102 and the transition device 410 of FIGS. 6 and 7. The ladder 102 comprises an I-section 444 along a front edge of the side face of the uprights 121. The uppermost exposed rung 111 of the lower section 112 of the ladder 102 is hollow such that an aperture 446 is provided on a side face of an uprights 121, the aperture extending from the side face of a first upright 121, to the side face of a second upright 121. In FIG. 9, the hooks 428 of transition device 410 have a tight hook formation such that they engage with the I-section 444 of the ladder uprights 121.

Referring to FIG. 10, there is shown a side view of the extension ladder assembly 300a similar to the extension ladder assembly 300 of FIG. 9, the extension ladder assembly 300a comprising an extension ladder 102 and a transition device 410a. Transition devices 410 and 410a differ in the size and conformation of the hooks 428 at the end of each arm 426. In FIG. 10, the hooks 428 of transition device 410a have a wider hook formation such that the hooks 428 engage with the aperture 446 on the side face of the uprights 121 i.e. they engage with an inside face of the hollow rung 111. It will be appreciated that only part of the rung 111 needs to be hollow for a suitable aperture 446 to be provided. In both arrangements 410 and 410a, the transition device is securely engaged with the rung 111 and is prevented from twisting or sliding by the bias provided by the spring portion 430 that urges the hooks 428 against the uprights 121.

Referring to FIG. 11a, there is shown a top view of an extension ladder assembly 400 comprising an extension ladder 102 and a transition device 510 according to an embodiment of the present invention fitted to the uppermost exposed rung 111 of the lower section of the ladder 102. Similarly to the transition devices 110, 210, 310 and 410, the transition device 510 comprises a single elongate rung portion 515 having an upper face 513, suitable for a user to stand on. The device 510 also comprises front and rear engagement formations 548, 550 that are integral with the rung portion 515 and extend longitudinally from each end of the rung portion 515 respectively. When the transition device 510 is engaged on the uppermost exposed rung 111 (as shown in FIGS. 11a and 11b), the front engagement formations 548 abuts against the uprights 121 on the front face 122 of the extension ladder 102 on each side of the transition device 510 and the rear engagement formations 550 abuts a back face 124 of each upright 121 of the ladder 102.

The device 510 also comprises a rung engagement means but differs from the other transition devices 110, 210, 310, 410 in that the rung engagement means is provided by arrangement of the rung portion 515 between the front 548 and rear 550 engagement formations. FIG. 11b shows how the front and rear engagement formations provide a rung engagement means such that the transition device 510 can be engaged with the uppermost exposed rung 111 of the lower section of the extension ladder 102.

In use, to fit the transition device 510 to the uppermost exposed rung 111 of the lower section of the extension ladder 102, it is envisaged that the user will climb the lower section of the ladder 102 holding the transition device 510. The user will fit the transition device 510 to the uppermost exposed rung 111 of the lower section 112 of the ladder 102 by positioning the rung portion 515 over the rung 111. Due to the front and rear engagement formations 448, 550 extending longitudinally from each side of the rung potion 515, it has been found that to fit the device 510, it is preferable to insert the transition device 510 above the rung 111 such that the device 510 is at an angle roughly 45° off the horizontal of the rung 111. The front and rear engagement formations 448, 550 on a first end of the transition device 510 can first be engaged with one upright 121 before angling the transition device 510 back to the horizontal to engage the front and rear engagement formations 448, 550 of the second end of the transition device 510 with the second upright.

The front and rear engaging formations 548, 550 brace the transition device 510 and prevent downward rotation when stepped on by the user. In this manner, a user will be able to step on the transition device 510 and climb safely between the lower section 112 and the upper section 114 of the extension ladder 102.

We now describe a further embodiment with reference to FIG. 12. A transition device 600 similar to transition devices 310 and 410 shown in FIGS. 5 to 7. Transition device 600 comprises a single elongate rung portion 602 having a single rear-wall 604. The transition device 600 further comprises a clamp 606 comprising a screw-bolt 608, a head 610 at a first end of the screw-bolt 608 and a clamping member 612 at a second end of the screw-bolt 608.

Screw-bolt 608 passes through an aperture 614 in the rear-wall 604. A washer 616 is welded to screw-bolt 608 so that when head 610 is rotated the screw-bolt 608 does not move backwards and forwards but simply rotates.

The clamping member 612 comprises a flat section 618 and is threadably engaged with the second end of the screw-bolt 608. Upon rotation of the screw-bolt 608, caused by the rotation of head 610, the flat section 618 of the clamping member 612 comes into contact with the underside of the transition device 600. As the screw-bolt 608 cannot move forwards or backwards, due to the welding of the washer 616 to the screw-bolt 608, the rotation of the screw-bolt 608 is translated by the contact between the flat section 618 and the underside of the transition device 600 to linear motion of the clamping member 612. The effect of this is that if the head 610 is turned in a first direction, the clamping member 612 moves forwards into contact with an exposed rung of the ladder 102, and if the head 610 is turned in a second direction, the clamping member 612 moves backwards away from the exposed rung of the ladder 102. This arrangement forms a clamp on the exposed rung of the ladder 102 to secure the transition device 600 on the exposed rung of the ladder 102.

Transition device 600 further comprises a plurality of compartments 620, 622 and 624 where tools and equipment can be kept whilst the transition device 600 is secured to the exposed rung of the ladder 102. This is illustrated in FIG. 13. Compartments 620, 622 and 624 are of different shape and size to enable the transition device to keep a wide variety of tools that could be used by a user who is using the ladder 102.

Embodiments of the transition device in accordance with the present invention are all simple and inexpensive in construction, yet can be securely fitted to the uppermost exposed rung of the lower section of an extension ladder to enable a user to step safely over the transition between the lower and upper sections of the extension ladder.

It will be appreciated that a transition device of the present invention may comprise any one or any combination of features described herein with reference to the drawings. For example, the transition device may simply comprise an elongate rung portion, an engagement means and a clamp arranged to abut said exposed rung to hold the device securely in place for the user to step on. Alternatively, the transition device may have one or more hook shaped arms for engaging to the rung as well as lock for securing the transition device. These are only some of many envisaged embodiments that are included in the scope of the present application.

1-27. (canceled)

28. A transition device for fitting to an uppermost exposed rung of a lower section of an extension ladder having one or more uprights and upper and lower ladder sections, said transition device comprising:
a single elongate rung portion having an upper face and a lower face; and,
a rung engagement clamp for abutting said uppermost exposed rung of the extension ladder, said rung engagement clamp comprising a screw-bolt having a head at a first end and a clamping member at a second end, said clamping member for engagement with a portion of said transition device, so that rotation of said head causes linear movement of said clamping member against said uppermost exposed rung of the extension ladder for securing said transition device to the extension ladder.

29. The transition device according to claim 28, wherein said single elongate rung portion has a non-slip formation.

30. The transition device according to claim 29, wherein said non-slip formation comprises a plurality of longitudinal rib formations on the upper face of said single elongate rung portion.

31. The transition device according to claim 28, further comprising wing formations project longitudinally from each end of said transition device, axially with said single elongate rung portion.

32. The transition device according to claim 31, wherein said wing formations comprise substantially flat abutment faces extending longitudinally of said transition device for abutting a front face of said one or more uprights of the extension ladder.

33. An extension ladder assembly comprising an extension ladder having an upper ladder section and a lower ladder section and a transition device, each of said upper ladder section and said lower ladder section comprising a pair of uprights and a plurality of rungs extending therebetween, said transition device comprising:
a single elongate rung portion with an upper face and a lower face; and,
a rung engagement clamp for abutting an exposed rung of the extension ladder, said rung engagement clamp comprising a screw-bolt having a head at a first end and a clamping member at a second end, said clamping member being for engagement with a portion of said transition device, so that rotation of said head causes linear movement of said clamping member against said exposed rung of the extension ladder for securing said transition device to the extension ladder.

34. The extension ladder assembly according to claim 33, wherein said single elongate rung portion has a non-slip formation.

35. The extension ladder assembly according to claim 34, wherein said non-slip formation comprises a plurality of longitudinal rib formations on the upper face of said single elongate rung portion.

36. The extension ladder assembly according to claim 33, further comprising wing formations project longitudinally from each end of said transition device, axially with said single elongate rung portion.

37. The extension ladder assembly according to claim 36, wherein said wing formations comprise substantially flat abutment faces extending longitudinally of said transition device for abutting a front face of said one or more uprights of the extension ladder.
